(19) United States
(12) Patent Application Publication
(10) Pub. No.: US 2021/0232819 A1
(43) Pub. Date: Jul. 29, 2021

(54) METHOD AND SYSTEM OF DETERMINING A RECOMMENDED PATHWAY THROUGH A PHYSICAL STRUCTURE ENVIRONMENT

(71) Applicant: Lenovo (Singapore) Pte. Ltd., New Tech Park (SG)

(72) Inventors: Russell Speight VanBlon, Raleigh, NC (US); William Holroyd, Holly Springs, NC (US); Philip Childs, Fort Wayne, IN (US)

(21) Appl. No.: 16/774,276

(22) Filed: Jan. 28, 2020

(51) Int. Cl. G06K 9/00; H04W 4/029; G06F 3/01; G06T 19/00

(52) U.S. Cl. CPC G06K 9/00671; H04W 4/029; G06T 19/006; G06F 3/017; G06F 3/011

(57) ABSTRACT

Computer implemented methods, systems, and computer program products are provided including obtaining one or more prior pathways through a physical structure environment (PSE) followed by a collection of electronic devices (EDs) over time in connection with the EDs navigating through the PSE; determining a recommended pathway through the PSE to a PSE destination based on the one or more prior pathways; and presenting the recommended pathway.

Embodiments of the present disclosure generally relate to automatically providing a recommended pathway to a user with an electronic device ED.

Today, a person in an unfamiliar building or campus may find it difficult to navigate and find rooms and other destinations. The difficulties may lead to delayed meeting start times and user frustration. Electronic devices (EDs) (e.g., cellular phones, tablet devices, laptop computers) support location services that allow a user to provide physical geographic locations of the electronic device. However, most current tracking services are configured to navigate a person in an outside environment along highways, city streets, and the like. To provide the location service, the ED utilizes an internal tracking system, such as a GPS chip set, to periodically broadcast the geographic location of the electronic device to a remote server or use dead reckoning.

Conventional GPS and dead reckoning solutions may route a person to a building, but once the person enters the building the tracking method becomes less reliable. Currently, building floor plans and layouts are not part of the GPS navigation map system.

A need remains for a navigation system and method to assist users in navigating in an indoor setting.

### SUMMARY

In accordance with embodiments herein, a method is provided. The method may comprise obtaining one or more prior pathways through a physical structure environment (PSE) followed by a collection of electronic devices (EDs) over time in connection with the EDs navigating through the PSE. The method may also comprise determining a recommended pathway through the PSE to a PSE destination based on the one or more prior pathways and presenting the recommended pathway.

Additionally or alternatively, in accordance with aspects herein, the recommended pathway may be determined independent of any geographic mapping data associated with the PSE. Additionally or alternatively, in accordance with aspects herein, the recommended pathway may be presented as audio, visual and/or tactile information. Additionally or alternatively, in accordance with aspects herein, the recommended pathway may also be presented by displaying the recommended pathway on a display of an augmented reality (AR) device. Additionally or alternatively, in accordance with aspects herein, multiple prior pathways may be presented on the display, emphasizing the recommended pathway amongst the prior pathways. Additionally or alternatively, in accordance with aspects herein, the pathways may be defined based on environmental related device captured (ERDC) data. Additionally or alternatively, in accordance with aspects herein, the recommended pathway may also be calculated using a current location of the ED, the PSE destination, and the ERDC data defining the pathways. Additionally or alternatively, in accordance with aspects herein, the ERDC data defining the pathways may be updated as office layouts, office identifiers, and the like change over time.

Additionally or alternatively, in accordance with aspects herein, obtaining one or more prior pathways may include accessing memory storing the one or more prior pathways. The pathways may be built by tracking position data for the collection of EDs over time while the EDs navigate through the PSE and identifying potential PSE destinations within the PSE. Building the pathways may also include analyzing the position data to identify the one or more prior pathways through the PSE to corresponding ones of the potential PSE destinations. Additionally or alternatively, in accordance with aspects herein, the position data may be recorded in a tracking log and may include a starting location, a destination, route information, tracking data, and potential PSE destinations.

In accordance with embodiments herein, a system is provided. The system may include a user interface, a processor, and a memory storing program instructions accessible by the processor, wherein, responsive to execution of the program instructions, the processor to obtain one or more prior pathways through a physical structure environment (PSE) followed by a collection of electronic devices (EDs) over time in connection with the EDs navigating through the PSE. The processors may also determine a recommended pathway through the PSE to a PSE destination based on the one or more prior pathways and present the recommended pathway.

Additionally or alternatively, in accordance with aspects herein, the processor may determine the recommended pathway independent of any geographic mapping data associated with the PSE. Additionally or alternatively, in accordance with aspects herein, the processor may present the recommended pathway as one or more of audio, visual and tactile information. Additionally or alternatively, in accordance with aspects herein, the processor may present the recommended pathway by displaying the recommended pathway on a display of an augmented reality (AR) device. Additionally or alternatively, in accordance with aspects herein, the processor may present multiple of the one or more prior pathways and emphasizes the recommended pathway one or more prior pathways.

Additionally or alternatively, in accordance with aspects herein, the processor may access memory to obtain the one or more prior pathways, wherein the processor may track position data for the collection of EDs over time while the EDs navigate through the PSE, may identify potential PSE destinations within the PSE, and may analyze the position data to identify the one or more prior pathways through the PSE to corresponding ones of the potential PSE destinations to build the one or more prior pathways. Additionally or alternatively, in accordance with aspects herein, the processor may access memory to record position data in a tracking log. The tracking log may include a starting location, a destination, route information, and potential PSE destinations. Additionally or alternatively, in accordance with aspects herein, the processor may access memory to calculate the recommended pathway using a current location of the ED, the PSE destination, and the ERDC data defining the one or more pathways.

In accordance with embodiments herein, a computer program product is provided. The computer program product may include a non-signal computer readable storage medium comprising computer executable code to obtain one or more prior pathways through a physical structure environment (PSE) followed by a collection of electronic devices (EDs) over time in connection with the EDs navigating through the PSE. Also, the computer program product may include a non-signal computer readable storage medium comprising computer executable code to determine a recommended pathway through the PSE to a PSE destination based on the one or more prior pathways and present the recommended pathway.

Additionally or alternatively, in accordance with aspects herein, the computer program product may include presenting the recommended pathway by displaying the recommended pathway on a display of an augmented reality (AR) device. Additionally or alternatively, in accordance with aspects herein, the computer program product may include presenting multiple of the one or more prior pathways and emphasizing the recommended pathway one or more prior pathways.

### BRIEF DESCRIPTION OF THE DRAWINGS

FIG. 1 illustrates a system that tracks electronic devices in accordance with embodiments herein.

FIG. 2 illustrates a block diagram of the modules, catalogues, data and other information that may be stored within the memory in accordance with embodiments herein.

FIG. 3A illustrates a process for collecting data from tracking electronic devices in accordance with embodiments herein.

FIG. 3B illustrates a process for updating mapping data of a physical structure environment in accordance with embodiments herein.

FIG. 4 illustrates a process for utilizing data for multiple pathways to determine a recommended pathway in accordance with embodiments herein.

FIG. 5A illustrates a bird's eye view of a physical structural environment with multiple pathways in accordance with an embodiment herein.

FIG. 5B illustrates a bird's eye view of a physical structural environment with multiple pathways and a recommended pathway in accordance with an embodiment herein.

FIG. 6 illustrates a bird's eye view of a physical structural environment with multiple pathways with no mapping information in accordance with an embodiment herein.

FIG. 7 illustrates a manner to display a recommended pathway on a portable electronic device in accordance with embodiments herein.

FIG. 8 illustrates a manner to display a recommended pathway and prior pathways on a portable electronic device in accordance with embodiments herein.

FIG. 9 illustrates a manner to display a recommended pathway in one or more lenses in an augmented reality headset in accordance with embodiments herein.

FIG. 10 illustrates a simplified view of communications between devices in association with providing a recommended pathway in accordance with embodiments herein.

### DETAILED DESCRIPTION

It will be readily understood that the components of the embodiments as generally described and illustrated in the Figures herein, may be arranged and designed in a wide variety of different configurations in addition to the described example embodiments. Thus, the following more detailed description of the example embodiments, as represented in the Figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “physical structure environment” and PSE shall mean an internal region of one or more buildings and/or an external region proximate to and surrounding one or more buildings. For example, an internal region within a physical structure environment shall represent doorways, entry areas, hallways, interior common areas, conference rooms, offices, meeting areas, cubicles, restrooms, stairways, and elevators. As another example, an external region within a physical structure environment shall represent exterior common areas, sidewalks and pathways around and between one or more buildings, and enclosed walkways (above ground or below ground) between interconnected buildings.

The term “PSE pathway” shall mean a route through the PSE, such as one or more hallways, stairwells, interior/exterior walkways proximate one or more buildings, and the like.

The term “PSE destination” shall mean a node along one or more PSE pathways within the PSE that represents an endpoint for one or more individuals traveling through the PSE, where the endpoint has an associated purpose of interest to the one or more individuals. Nonlimiting examples of PSE destinations include conference rooms, cubicles, elevators, restrooms, stairwells, common areas and the like.

The terms “environment related device captured data” and “ERDC data” shall mean data that is captured or otherwise collected by an ED, for which position data is tracked, where the data relates to, contains information concerning, or in indicative of, a destination related feature of interest for the PSE. By way of example, the ERDC data may represent a designation for a PSE destination within the PSE, such as a designation for a conference room (e.g., name, number or location), doorway, entry area, hall way, interior common area, office, meeting area, cubicle, exit, restroom, stairway, elevator and the like. As another example, the ERDC data may be a designation for an external feature of interest, such as an exterior common area, sidewalk or pathway around and between one or more buildings, an enclosed walkway, and the like. As further examples, the ERDC data may include a name or other descriptor of the FOI. Additionally, or alternatively, the ERDC data may include an image or video (e.g., captured by a camera on the ED) of the FOI.

The term “ED” shall mean an electronic device that is carried by an individual while navigating within a PSE. An ED may be utilized as a “pathway sourcing ED,” wherein position data is collected from the ED while the ED navigates through the PSE and/or wherein ERDC data is collected from the ED while navigating through or located at various destinations or nodes within the PSE. An ED may be utilized as an “destination ED,” wherein the destination ED determines a recommended pathway and/or presents the recommended pathway. The same ED may be utilized as a pathway sourcing ED and a destination ED.

For example, at one point in time, while an individual carries an ED throughout a PSE, the ED generates position data indicative of locations of the ED while navigating through the PSE. The ED, another ED and/or a remote server may then analyze the position data to identify the corresponding pathway (representing one of the one or more prior pathways). The ED, another ED and/or a remote server may then analyze the position data to identify potential PSE destinations. Continuing with the present example, at another point in time, the individual may desire to navigate to a PSE destination. The same ED may operate as a destination ED that determines a recommended pathway and/or presents the recommended pathway.

In accordance with embodiments herein, methods, systems, and computer program products are provided that enhance navigation through an environment based on a collection of prior pathways taken by others in the environment. For example, an individual may know a room number where a forthcoming meeting takes place in an environment but may not know how to navigate through the environment to the meeting room in a timely fashion. In accordance with new and unique aspects herein, the individual may obtain directions to the meeting room from a navigation system within the environment. The request may be also be triggered by a meeting reminder in the individual's electronic device. The environment related device captured data from the individual's electronic device and from previously tracked electronic devices may be obtained and analyzed, combining the data with navigation tools to provide reliable navigation assistance along a pathway through an environment. Movements of the individual may be tracked via WiFi nodes, GPS, and/or dead reckoning. Embodiments herein allow the individual's PSE destination requests to be paired with an indoor navigation system. As one nonlimiting example, the individual may utilize an augmented reality feature in a phone, smart glasses or the like to access an indoor environment and obtain detailed navigation that follows a recommended pathway derived from previous pathways taken by other individuals within the PSE. Hallways, doors, and turns can be recognized and highlighted as they are encountered in real time in the real world.

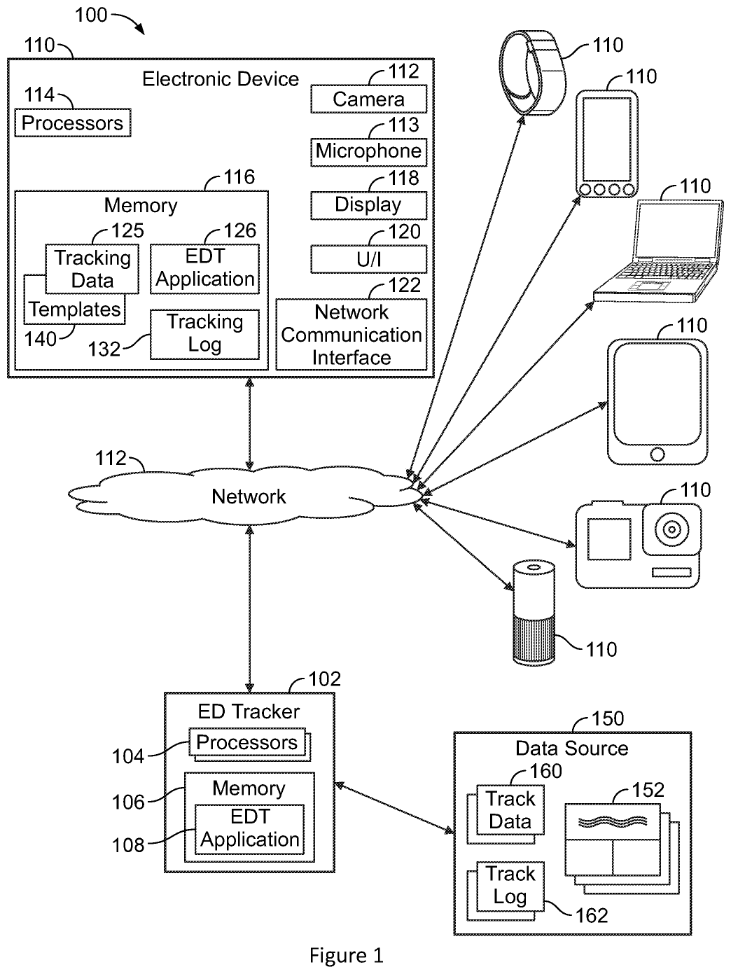

FIG. 1 illustrates a system 100 that tracks EDs, obtains pathways, and determines recommends pathways in accordance with embodiments herein. The system 100 includes one or more electronic devices 110 that communicate with one another over a network 112. Optionally, the EDs 110 may communicate through a wholly or partially wired subsystem. The network 112 may represent the World Wide Web, a local area network, a wide area network and the like. The EDs 110 may represent various types of EDs including, but not limited to, smart phones, desktop or laptop computers, tablet devices, smart watches, portable or handheld cameras, recording devices, digital personal assistant (DPA) devices and the like. In addition, the EDs 110 may represent various types of devices configured to detect locations, movements and the like.

At least one of the EDs 110 may be configured to implement tracking in accordance with embodiments herein. The ED 110 that is configured to implement tracking includes one or more processors 114, memory 116, a display 118, a user interface 120, a network communications interface 122, and various other mechanical components, electrical circuits, hardware and software to support operation of the client device 110. It is recognized that not all electronic devices 110 include a display, user interface, and the like. For example, a fixed or handheld camera may simply include camera related electronics and network circuitry to support communication to and from the camera.

The electronic device 110 includes one or more cameras 112 and microphone 113. The cameras 112 are configured to capture still and/or video data regarding an environment surrounding the electronic device. The microphone 113 is configured to capture audio data regarding the environment surrounding the electronic device. Optionally, the same cameras 112 and microphone 113 may be utilized throughout navigation to collect additional audio, image and video data regarding the environment surrounding the electronic device as environment related device captured (ERDC) data. The ERDC data may be used during navigation to track the present location of the user and collect movement information, such as when GPS functionality is not available. The user interface 120 may include a variety of visual, audio, and/or mechanical devices. For example, the user interface 120 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the user interface 120 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the user interface 120 may include a touch sensitive screen, a non-touch sensitive screen, a text-only display, a smart phone display, an audio output (e.g., a speaker or headphone jack), and/or any combination thereof. The user interface 120 permits the user to select one or more of a switch, button or icon in connection with various operations of the device 110.

The network communications interface 122 provides a direct connection to other devices, auxiliary components, or accessories for additional or enhanced functionality, and in particular, can include a USB port for linking to a user device with a USB cable. Optionally, the network communications interface 122 may include one or more transceivers that utilize a known wireless technology for communication.

The memory 116 can encompass one or more memory devices of any of a variety of forms (e.g., read only memory, random access memory, static random-access memory, dynamic random-access memory, etc.) and can be used by the processor 114 to store and retrieve data. The data that is stored by the memory 116 can include, but need not be limited to, operating systems, applications, and other information. Each operating system includes executable code that controls basic functions of the communication device, such as interaction among the various components, communication with external devices via a wireless transceivers and/or component interface, and storage and retrieval of applications and data to and from the memory 116. Each application includes executable code that utilizes an operating system to provide more specific functionality for the communication devices, such as file system service and handling of protected and unprotected data stored in the memory 116.

The memory 116 further includes, among other things, an ED tracking (EDT) application 126, tracking data 128, a tracking log 132 and one or more templates 140. The functionality of the EDT application 126 is described below in more detail. The templates 140 may include one or more types of templates that are descriptive of, and associated with, PSE destinations. More than one type of template (e.g., images, audio signatures, positions) may be associated with PSE destinations, For example, image-based templates may include still or video images, such as pictures/videos of hallways, rooms, room numbers and the like associated with a PSE destination, where the images are taken from different angles, with different lighting, and at different distances from the PSE destination. As another example, hallway images, still and/or video, may be captured from various EDs along various pathways, some from an east bound perspective, others from a west bound perspective during various times of the day along the way to a PSE destination. Audio-based templates may include sounds associated with a particular location, such as a refrigerator, a coffee machine, and/or running water at a sink associated with a kitchen area. Another example may include the sounds of printers/copiers associated with a specific room or area. In other words, the audio-based template may include sounds that are consistent or frequent enough to be part of the ambient sounds of a particular location. Position-based templates may identify a particular location associated with an ED tracked via a WiFi node in a particular location, such as a user's cell phone tracked in that user's office over time (e.g., Tom's cell phone is used to identify Tom's office because the cell phone is almost always in the office during work hours). Optionally, triangulation to WiFi nodes for a network may be used to identify locations (e.g., conference room WiFi node may be strongest, east to west WiFi nodes are equally strong).

The tracking data 128 may include one or more types of position data based on the electronic device 110 that collects the position data. The tracking data may be GPS, dead reckoning, ERDC data, and the like. The tracking data may be collected over the network 112 from numerous types of EDs 110 that implement a tracking operation (also referred to as tracking devices). For example, cell phones and cameras may collect image-based ERDC data, while cell phones, smart watches, digital personal assistance and the like collect audio-based ERDC data and position data.

The EDT application 126 generates and stores route information that defines the pathways. The route information may represent GPS coordinates (even though map data is not known for a PSE), dead reckoning coordinates, and the like. The route information may be defined with respect to ERDC data, such as the hallway by the water cooler, the stair way by the east end WiFi node, and the like. The EDT application 126 is configured to track position data for the collection of EDs over time while the EDs navigate through the PSE, identify potential PSE destinations within the PSE; and analyze the position data to identify the one or more prior pathways through the PSE to corresponding ones of the potential PSE destinations.

As explained herein, the EDT application 126 utilizes the templates 140 to analyze the tracking data 126 to identify pathways and potential PSE destinations. The EDT application 126 updates the tracking log 132 based on the analysis and provides feedback to the user concerning pathways regarding where a PSE destination may be located. The tracking log 132 maintains various information concerning pathways associated with PSE destinations. By way of example, the tracking log 132 may include routing information concerning ED starting locations, PSE destination locations, and pathways. The starting location for an ED may be stored into the tracking log as GPS coordinates, a triangulated location from WiFi nodes, an office location derived by ERDC data, and the like. The PSE destination locations may be stored as room numbers, GPS coordinates, and the like. Pathways may be stored as routing information with directions such as, “in 20 feet turn left at the next hallway.” Additionally or alternatively, the pathways may be stored as tracking data corresponding to one or more of GPS data, ERDC data, dead reckoning data, or WiFi node data.

In the foregoing example, the ED 110 implements the EDT application 126 locally on a device that may be generally present within the physical area of a user. For example, the ED 110 may represent the user's cell phone, laptop computer, tablet device, DPA device and the like.

Additionally or alternatively, all or portions of the EDT application 108 may be implemented remotely on a remote resource, denoted in FIG. 1 as an ED tracker 102. The ED tracker 102 may perform limited operations, such as manage storage and creation of templates. The ED tracker 102 may provide access to one or more memory 150, and/or implement the EDT application 108. The ED tracker 102 communicates with electronic devices 110 through one or more networks 112 to provide access to ED templates 140. The ED tracker 102 may represent a server or other network-based computing environment. The ED tracker 102 may represent a single computer system or a collection of computer systems located at a common location or geographically distributed.

The ED tracker 102 includes one or more processors 104 and memory 106, among other structures that support operation of the object tracker 102. In accordance with embodiments herein, the ED tracker 102 receives requests from various EDs 110 and returns resources in connection there with. It is recognized that the ED tracker 102 performs other operations, not described herein, such as operations associated with maintaining resources and the like.

The memory 150 may store the ED templates 140 organized in various manners and related to a wide variety of EDs and types of tracking data. The ED templates 140 may be based on different types of information, such as image data, video data, audio data, and position data. Optionally, the memory 150 may store tracking data 160, such as when the ED tracker 102 receives tracking data from EDs 110 that are performing tracking operations. Optionally, the memory 150 may store tracking logs 162, such as when the ED tracker 102 performs ED tracking operations at the request of an ED 110.

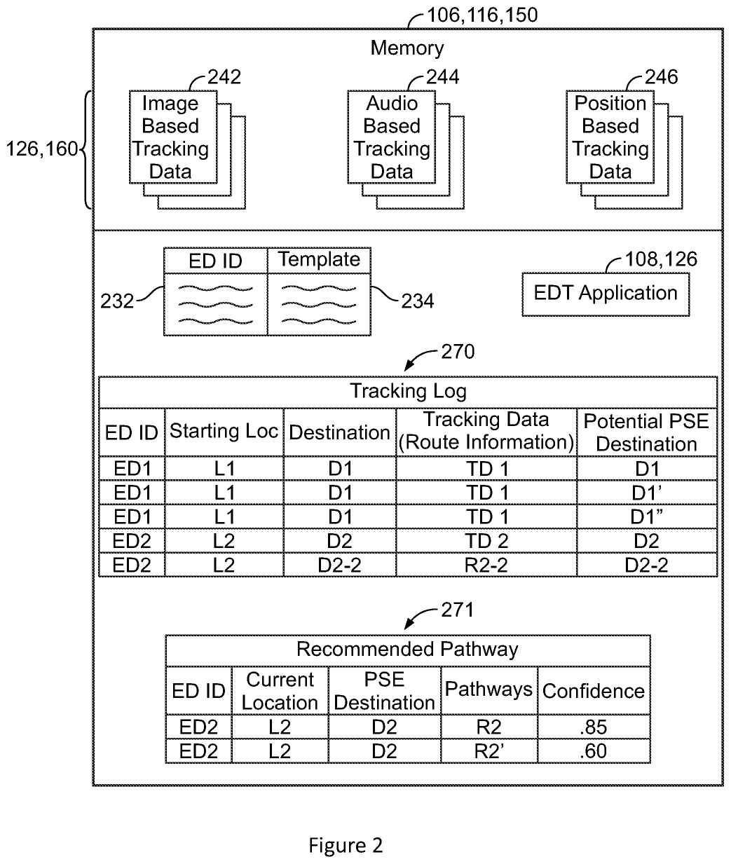

FIG. 2 illustrates a block diagram of the modules, catalogues, data and other information that may be stored within the memory 106, 116 and/or the memory 150 in accordance with embodiments herein. The EDT application 108, 126 includes program instructions accessible by the one or more processors to direct a processor to implement the methods, processes and operations described herein including, but not limited to the methods, processes and operations illustrated in the Figures and described in connection with the Figures. The EDT application 108, 126 includes one or more modules that operate in connection the various functions and features as described herein.

The memory 106, 116, 150 stores various types of tracking data 128, 160 (see FIG. 1), such as image-based tracking data 242, audio-based tracking data 244, and position-based tracking data 246. The memory 106, 116, 150 also stores a list 232 of ED identifiers associated with various types of EDs to be tracked, and templates 234 that may be used in connection with each type of ED. As explained herein, the templates 234 may be based on different types of information, such as images, video, audio, positions and the like. The image-based tracking information may include images of the PSE including various hallways, coffee machines, stairwells, printers, and the like. The audio-based tracking information may include the ambient sounds within the PSE, such as the sounds of the brewing coffee machine, water running in the kitchen area, the printer, a refrigerator, and the like. The position-based tracking data may include the signal strength of the WiFi connection to the EDs as they move throughout the PSE. WiFi nodes may be located in one or more locations throughout the PSE.

The memory 106, 116, 150 may also store a tracking log 270 that is maintained and updated in connection with particular EDs presently being tracked. For example, the tracking log 270 may maintain a running list of pathways for a particular ED, where each pathway represents a route to a potential PSE. For example, the tracking log 270 may include information concerning an ED identifier, a starting location of the ED, a destination location of the ED, tracking data and/or route information, and potential PSE destinations. In one embodiment, the tracking log 270 stores the raw tracking data. Additionally or alternatively, the tracking log 270 may store route information. For example, the tracking data may be analyzed to identify route information, and the route information is stored in the tracking log. As a further example, when the tracking data corresponds to GPS coordinates, the tracking log 270 may store the raw GPS coordinates as the tracking data and/or store a route or routing information, derived from the GPS coordinates. As an additional example, when the tracking data represents ERDC data, the raw ERDC data may be store in the tracking log 270 (e.g., images captured along a pathway, audio segments recorded in connection with an environment along a pathway). Additionally or alternatively, the ERDC data may be analyzed to derive routing information based thereon. For example, when the ERDC data represents images that are collected at intermittent periods while a user is carrying a smart phone along a hallway, the images representing ERDC data may be analyzed to identify routing information. The routing information may be representative of a path defined with respect to a coordinate system (e.g., traveling east). The routing information may indicate a distance traveled in a particular direction (e.g., traveling 300 feet east, then turning north traveling 50 feet, then turning to face west to enter a destination).

In one embodiment, with reference to FIG. 2 the tracking log 270 records ED1 starting at location L1 with a destination location of D1. The tracking data is represented by TD1, and the potential PSE destinations are D1, D1′ and D1″ (where D1′ and D1″ may be locations along the pathway to D1). ED2 may be tracked starting at location L2 on the way to destination D2. The tracking data stored from ED2 is represented by TD2 and the potential PSE destination corresponds to D2. However, ED2 may proceed to a second destination D2-2. Route information R2-2 may be stored in accordance with the route between starting location L2 and D2-2. The tracking log 270 is built as described herein over time. When an individual needs to travel to a particular PSE destination, a recommended pathway is calculated as described herein.

The memory also stores the recommended pathway 271 that is calculated using the user's current location, the PSE destination, one or more pathways, and a confidence rating. For example, ED1 may start at location L1 and proceed to PSE destination D1 along recommended pathway R1. There may not be a value calculated for a confidence rating, because there is only one recommended pathway. However, a confidence rating may be calculated if there are multiple recommended pathways presented to the user. For example, ED2 may start at location L2. There may be two pathways (R2 and R2′) to PSE destination D2. A confidence rating may be assigned to each pathway. For example, a recommendation for pathway R2 may have a confidence rating higher than a recommendation for pathway R2′, because pathway R2′ is the slower pathway to PSE destination D2.

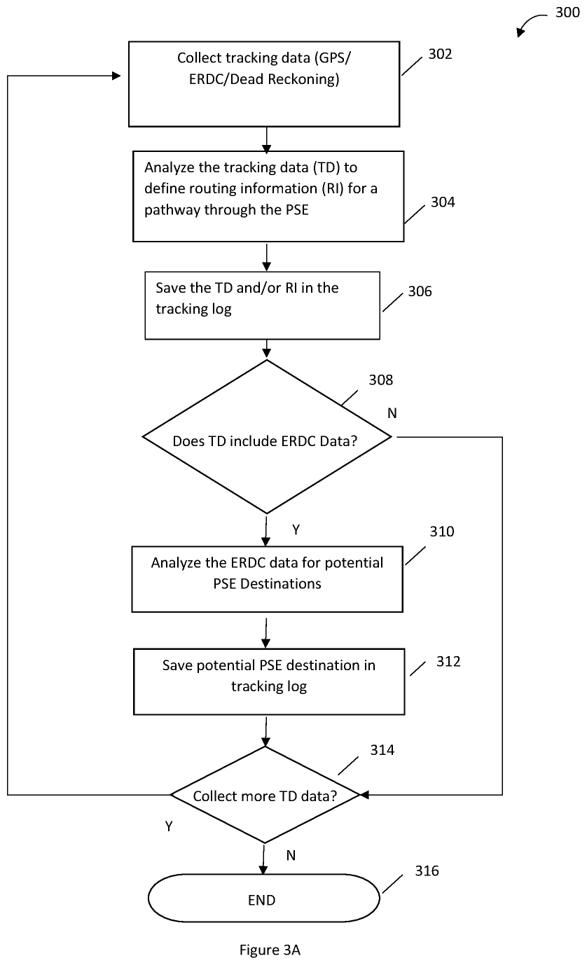

FIG. 3A illustrates a process 300 for tracking position data for a collection of electronic devices over time in accordance with embodiments herein. The operations of FIG. 3A are carried out by one or more processors 114 of an ED 110 in response to execution of program instructions, such as in the EDT application 126, and/or other applications stored in the memory 116. For example, a single ED or a group of two or more EDs may track position data for multiple other EDs over time that also includes image and/or audio-based data. The same single ED and/or group of two or more EDs may then analyze the position data to identify prior pathways and ERDC data to identify potential PSE destinations. Additionally or alternatively, the operations of FIG. 3A may be carried out by the processors 104 within one or more servers at the tracking manager 102 in response to execution of program instructions, such as in the EDT application 108.

At 302, the one or more processors track and collect position data for one or more electronic devices in connection with tracking movement by a collection of EDs. For example, users of EDs willing to contribute to a database containing position data for a given PSE opt-in and the position data is thereby tracked. The position data may be a series or set of data points, data vectors (e.g., direction and distance), and the like. The EDs are tracked at various locations within an established PSE boundary. The boundary may include only areas inside of the PSE. Optionally, the PSE tracking boundary may extend to areas outside of the PSE building. Optionally, the PSE may be part of a campus of buildings, which may expand the PSE boundary. The EDs may be tracked within the entire campus, including the inside and outside of various buildings that make up the PSE. The data may be collected by EDs configured to track the movements of other EDs. The EDs may track and collect the position data from other EDs. Optionally the position data may be relayed to one or more remote servers.

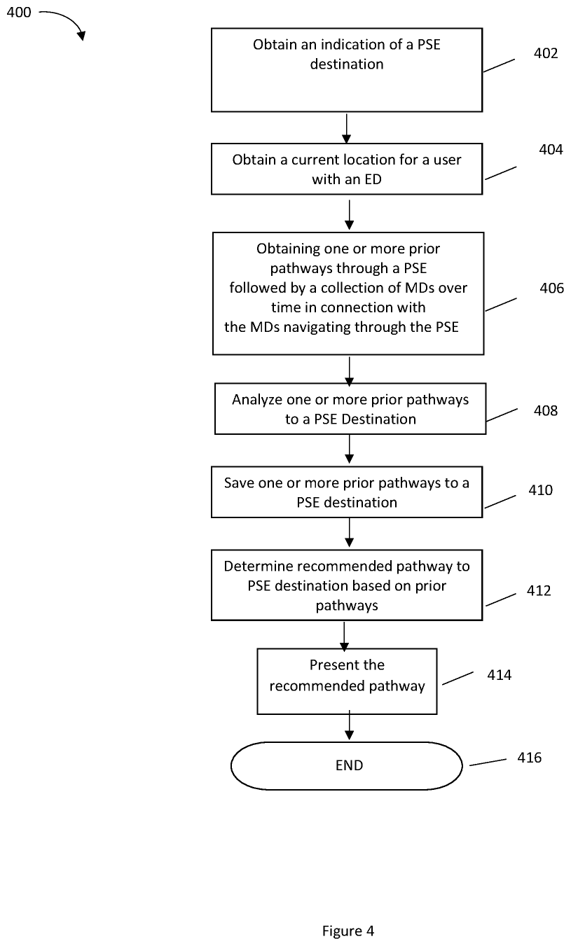

FIG. 5A illustrates a bird's eye view of a PSE. Tracked ED 560 proceeds along pathways (dashed lines) from cubicle 562 to various locations. These locations may include the kitchen area 520 along pathway 561a, an associate's office 518 along pathway 561c, another associate's cubicle 564 along pathway 561d, and/or conference room 515 along pathway 561b. The position data is collected for each pathway taken by the ED to each location. Another example from FIG. 5A involves ED 570, that may move along pathways from cubicle 566 to various locations within the PSE. ED 570 may be tracked proceeding to the restroom 505, along pathway 571d, an associate's cubicle 563, along pathway 571a, another associate's cubicle 565, along pathway 571c, and/or conference room 515 along pathway 571b.

The position data may include GPS coordinates indicative of a location of the ED at various points in time. For example, on a campus of buildings, position data may be comprised of GPS coordinates. The tracked EDs may be tracked via GPS satellites along various pathways within various PSE destinations. The position data may be collected as longitude and latitude coordinates as well as street addresses where the given ED has traveled over a period of time. In the example illustrated in FIG. 5, the GPS data allows tracking of EDs along pathways inside a PSE, such as pathways 561a-d, 571a-d, 551a-h, and recommended pathway 551.

Additionally or alternatively, the position data may be “dead reckoning” related data, such as directional information, speed information, travel time information and the like. For example, the position data collected by dead reckoning may be based on plotting a known ED position, such as kitchen area 520 in FIG. 5A. Using the direction and speed of the ED, future positions may be estimated. For example, if ED 560 in FIG. 5A proceeds toward a PSE destination, such as conference room 515, westbound at 2.5 miles per hour, dead reckoning may be used to estimate what time the user will arrive at the PSE destination.

Additionally or alternatively, the position data may include ERDC data that is used as “association” based position information, such as detection of WiFi nodes (identified by WiFi node ID), signal strength of a communication link with the node and the like. For example, in FIG. 5A, ED 570 may be tracked by WiFi node-2 530a located by the stairwell. The strong signal strength near the stairwell may establish a position for ED 570. The signal strength is strongest by the stairwell but may reach throughout the PSE. The signal strength of WiFi node-2 530a may be used to track ED 270 along pathways 571a-d. Additionally, or alternatively WiFi node-1 530b located in conference room 515 may provide a stronger signal to establish a position of ED 570 in the conference room 515 or other locations on the other side of the PSE. Tracking log 270 in FIG. 2 may collect both sets of tracking data. Optionally, only position data tracked via the strongest signal may be collected in the tracking log 270.

Additionally or alternatively, the position data may include ERDC data that is used as association-based position information, such as images, video, and audio as ERDC data. For example, in FIG. 5A, ED 560 may be tracked proceeding away from cubicle 562. Images along pathway 561b may include cubicle numbers or name plates on the cubicles along pathway 561b. Videos along pathway 561b may include videos of the cubicles and name plates as well as movement along pathway 561b, such as a ceiling fan. Audio along pathway 561b may include printer/copier sounds, the sounds of a ceiling fan, and the like along the pathway 561b.

Additionally or alternatively, the ERDC data may be determined directly by a first ED, indirectly by a second ED and/or indirectly by a remote server. For example, each ED may process information collected by the ED to generate the associated ERDC data. For example, an ED may capture images/videos while the ED moves throughout the PSE. The ED may then directly analyze the images/videos for features of interest (FOI) (e.g., conference room numbers/IDs, exit signs, stairs signs). As another example, the ED may access a calendar application on the ED and identify names or designators for meeting locations associated with a current time. For example, a calendar may designate a meeting is scheduled at 1:00 pm to be held in “Conference Room 3”. At the designated time, the ED may record current position date (e.g. GPS coordinates, Wi-Fi node triangulation information) of the ED in connection with a PSE destination named “Conference Room 3.”

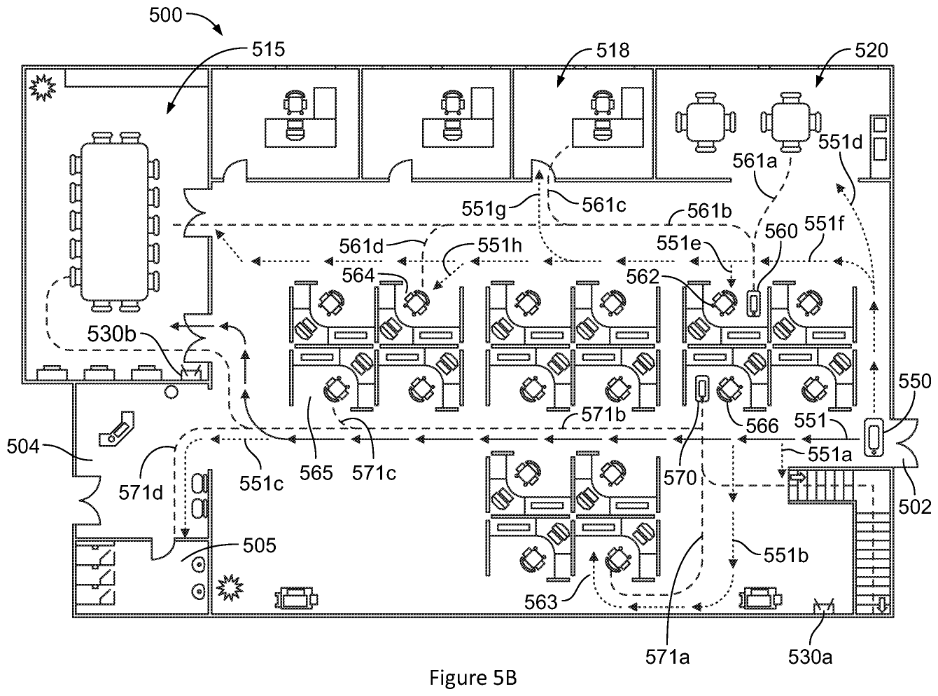

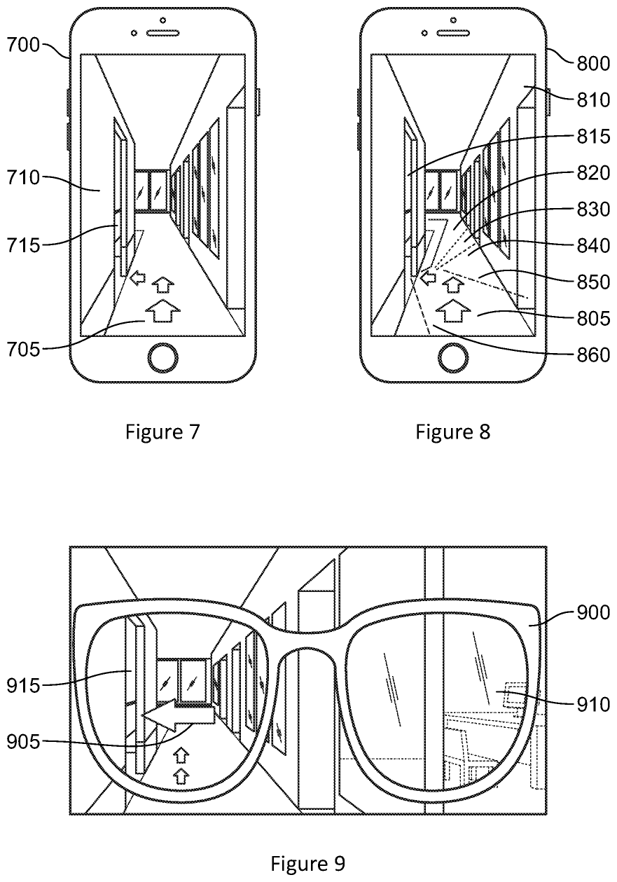

For example, in FIG. 5A, the one or more processors may collect ERDC data from EDs 560 and 570. The EDs may record video, still images, and audio of the route taken by each ED to various PSE destinations. One or both EDs may collect room numbers, ambient sounds, and the like associated with the route taken within the PSE. ERDC data may be captured from the EDs along the pathways during the tracking activity. For example, in FIG. 7, a user proceeding along a pathway with an ED may collect ERDC data, such as pictures, videos, and/or sounds along the pathway. In another example in FIG. 9, a user proceeding along a pathway with AR goggles may also collect ERDC data.

Additionally or alternatively, the one or more processors of a destination ED and/or remote server may determine the ERDC data from images, videos, calendar events or other data sources on the first ED.

Optionally, map data of the PSE may be provided by the ED, maintained at the device, system or network implementing the operations of FIG. 3A, and/or requested from a remote server. The map data may define various aspects of a physical environment, such as a floor plan for a building, collection of buildings (e.g., office, educational, hospital campus), and the like. The map data may also include popular destinations within the PSE, such as water fountains, copiers/printers, and the like.

For example, in FIG. 5A, the map data of the PSE may be provided by the one or more processors. The map data may be presented as the floor plan of the PSE as illustrated in FIG. 5A. Additionally, the map data includes copier/printer locations and WiFi node locations. These locations may be provided as supplemental map data by tracked EDs that have frequently stopped at the location and obtained ERDC data along a prior pathway. The position data is obtained independent of the map data. However, once position data is obtained, the map data may be presented with the position data.

At 304, the one or more processors analyze position data to identify one or more prior pathways through a PSE followed by the collection of the EDs over time in connection with the EDs navigating through the PSE. For example, the one or more processors may analyze position data that tracks ED movement from a user's cubicle to the cafeteria, to an associate's desk, to a conference room, to a restroom and back to the user's cubicle. Additionally or alternatively, one or more sets of templates may be uploaded to ED 110 from a database or server (e.g., ED tracker 102). Additionally or alternatively, a user may identify generic baseline templates, such as from Internet searches, photographs and the like. For example, the one or more sets of templates may contain image-based or video-based tracking data that contains pictures and/or video along a pathway of hallways, office numbers, and the like, comparing previously captured images/video in the template to images/video captured from a current ED to determine the location of the ED. Also the one or more sets of templates may contain audio-based tracking data that contains sounds captured along a pathway such as the hum from a refrigerator in the kitchen area, the sound of the copier/printer in the hallway, sound of the fan blowing air through vents, and the like. These previously captured sounds are compared to the sounds being captured from a current ED moving around a PSE to determine the location of the ED. After the position data has been analyzed by the one or more processors, the position data may now be used to identify prior pathways that may be utilized to provide directions to the user's cubicle, the cafeteria, the conference room, the restroom and the like. A pathway marker may indicate the locations. Each time the ED takes a route within the PSE, the position data concerning the route may be saved as a prior pathway. Similarly, other EDs provide position data, which also is saved as prior pathways as the EDs move within the PSE.

For example, in FIG. 5A, the position data analyzed from the tracked EDs is used to define prior pathways. The position data analyzed in association with route 561a taken by ED 560 from cubicle 562 into the kitchen area 520 defines a first prior pathway. Similarly, position data concerning the route of ED 560 to various other locations within the PSE are analyzed by the one or more processors and defines corresponding prior pathways, such as 561b (a prior pathway to the conference room) and 561c (a prior pathway to an associate in office 518).

As another example, in FIG. 3B, the templates may be updated as the PSE layout changes over time. This occurs within the process at 304. For example, the one or more processors may analyze position data that tracks ED movement from the front door of the PSE past elevators, restrooms, desks with cubicle or office identifiers, conference room identifiers, emergency exit signs, and the like may continue to collect ERDC data during the route to a colleague's desk.

At 320 the one or more sets of templates may contain image-based or video-based tracking data that contains pictures and/or video along a pathway of hallways, office numbers, and the like, comparing previously captured images/video/sounds in the template to images/video/sounds captured from a current ED to determine the location of the ED.

At 340 the one or more processors determine whether the current ERDC data is the same as the stored ERDC data. For example, current ERDC data may indicate via recently captured images/videos/sounds that another restroom has been added on another floor of the PSE. There may be pictures and videos captured of a room number, typical restroom signs, and the like. There may be sounds of running water captured as well. The stored templates may indicate an open area in the same location prior to recent ERDC data captures from tracked EDs. If the ERDC data is determined to be consistent with the ERDC data stored in the templates, the process will proceed to 304d. If the ERDC data is not determined to be consistent, the one or more processors may proceed to 304c.

At 360, the one or more processors may update the image/video/sound-based templates as the captured ERDC data changes over time. For example, a remodeling project to accommodate new hires may result in offices, cubicles, conference rooms, and the like being relocated. The tracked EDs provide updated tracking information corresponding to the updated PSE destinations. The PSE navigation system is thereby updated as more tracked EDs provide updated ERDC data, resulting in a new map for the office. The captured image/video/sound templates are updated with the new PSE layout that may include new office/cubicle numbers or old office/cubicle numbers in a new location.

At 380, the one or more processors end the process. For example, the one or more processors have analyzed a sufficient amount of ERDC data to determine that the one or more sets of templates are current with the current PSE layout. The map of the office is up to date, so the process proceeds to 306.

For example, in FIG. 5A, the position data analyzed in association with route 561a taken by ED 560 from cubicle 562 into the kitchen area 520 defines a first prior pathway. However, if cubicle 562 is renamed, removed, or relocated, the current video/image/sound data from ED 560 and other tracked EDs will be captured and compared to previous video/image/sound data for the location by the one or more processors. The cubicle identifier 562 may be captured by tracked EDs at a location on another floor (not shown). The templates will be updated to reflect the changes noted by the one or more processors based on the new position data, thereby updating the navigation map of the office.

At 306, the one or more processors save the tracking data and/or routing information in the tracking log. For example, an ED is tracked from a starting location along a pathway to a PSE destination. The tracked data and/or routing information is saved in the tracking log. The tracking data for a route may include a set or series of GPS data points/vectors, ERDC data points/vectors, and/or dead reckoning data points/vectors. The routing information may include the one or more pathways traveled by an ED along the way to a PSE destination. The PSE destination may be stored as the last point along the route, such as the last GPS coordinate, last ERDC data point, last dead reckoning data point, and the like.

For example, in FIG. 2, tracking data TD 2 from ED2 starting from location L2 to PSE destination D2 is saved in tracking log 270. Also, routing information R2-2 from ED2 starting from location L2 along the pathway R2-2 to PSE destination D2-2 is saved in tracking log 270.

At 308, the one or more processors determine whether the saved tracking data includes ERDC data. The ERDC data may include images, videos, and audio collected along various pathways within a PSE. For example, still pictures and video captured by the one or more processors along a pathway to a PSE destination may include such identifiers as a bright light emanating from large windows/doors in the lobby or a poster on a cubicle wall. Audio captured by the one or more processors may include sounds emanating from a window frequently left open or a frequently used paper shredder. If the one or more processors determine that the saved tracking data includes ERDC data, the process proceeds to an analysis step at 310. If the one or more processors determine that the saved tracking data does not include ERDC data, the one or more processors proceed to collect more tracking data at step 314.

At 310, the one or more processors analyze the ERDC data to identify potential PSE destinations along the one or more prior pathways. For example, an ED provides the ERDC data. The data may include position data, pictures, videos, ambient sounds, and the like. This data from a current ED may be compared with the data in the image/video/audio-based templates stored in memory to locate the current ED. The one or more processors may use the current ED location to determine prior pathways to PSE destinations along the current path of the current ED, deriving several potential PSE destinations along that prior pathway. An ED proceeding down a pathway with an office, three cubicles, and a water fountain may provide five potential PSE destinations to the processor. The processor may also derive more potential PSE destinations when considering other EDs that have taken a similar pathway but opted to go back in another direction after visiting a particular office, the cafeteria, the restroom, and the like. If the one or more processors determine that the ERDC data has not been analyzed to identify potential PSE destinations along a pathway, the one or more processors will continue to obtain ERDC data as shown at 304.

Optionally, the prior pathways are defined based on the ERDC data. The captured images, videos, and sounds may be associated with movement within the PSE. For example, a pathway to a PSE destination such as an associate's cubicle may include proceeding by an air conditioning/heating vent, a vending machine, and the like. There may only be one prior pathway within the PSE that contains that particular combination of corresponding ERDC images, videos, and sounds. The prior pathway may then be associated with that ERDC data and defined by the air conditioning/heating vent, vending machine, and the like. The

[symbol]

For example, in FIG. 5A, the ERDC data from users 560 and 570 is analyzed. The routes taken by the users are analyzed to identify potential PSE destinations. The one or more processors analyze the ERDC data by comparing the image/video/audio-based data in the templates to the image/video/audio data captured from a current ED. The image/video-based template may contain pictures/videos of a poster on the wall, a plant, a wall clock, and the like. The comparison of the data captured by the current may yield the same PSE elements along a pathway. The potential PSE destinations are calculated based on the calculated location of the current ED and the prior destinations stored in memory from previous EDs. The potential PSE destinations are denoted in FIG. 5A as locations along or at either end of a dashed line. The ERDC data includes image, video, audio, and position data captured along pathways to be analyzed by the one or more processors. The one or more processors analyze the ERDC data associated with prior pathway 561a, and identify a potential PSE destination, kitchen area 520, along the pathway. Likewise, the one or more processors analyze prior pathway 561c and identifies potential PSE destination office 518 along the pathway.

At 312, the one or more processors store the one or more prior pathways through the PSE along with associated potential PSE destinations in the tracking log. For example, an ED may provide various pathways within the PSE. Each route taken by the ED to a destination is stored by the one or more processors in the tracking log. As the pathways are stored, each pathway becomes a prior pathway that is added to the collection of prior pathways collected by the one or more processors. In operation, an ED takes various pathways throughout the day. Each pathway taken during that day is then stored by the one or more processors. As an example, three routes by an ED to the cafeteria directly or with stops along the way are stored and become prior pathways within the PSE that are associated with potential PSE destinations such as the cafeteria and the stops made along the way to the cafeteria. It is understood that the operations at 302-306 may be performed continuously, at select times of day, at the instruction of a user, in a manner selected by the user and the like. For example, a user may decide to opt out of being tracked. The device movements may then cease to provide pathways that add to the collection of prior pathways.

For example, in FIG. 5A, prior pathways traveled by EDs 560 and 570 are stored along with potential PSE destinations. ED 560 has prior pathway 561a that is stored along with associated potential PSE destination 520, the kitchen. ED 560 also has prior pathway 561b that is stored along with associated potential PSE destination 515, the conference room.

At 314, the one or more processors determine whether to collect more tracking data. If the one or more processors determine that more tracking data is to be collected, the process proceeds back to tracking data collecting step 302. The determining may be based upon the one or more processors having stored a sufficient collection of pathways. For example, the one or more processors may determine that the tracking log has an insufficient amount of tracking data to properly calculate pathways to potential PSE destinations. Accordingly, the one or more processors may determine that more tracking data is needed, and the collection of tracking data may continue. If the one or more processors determine that there is no need for additional tracking data collection, the process proceeds to 316.

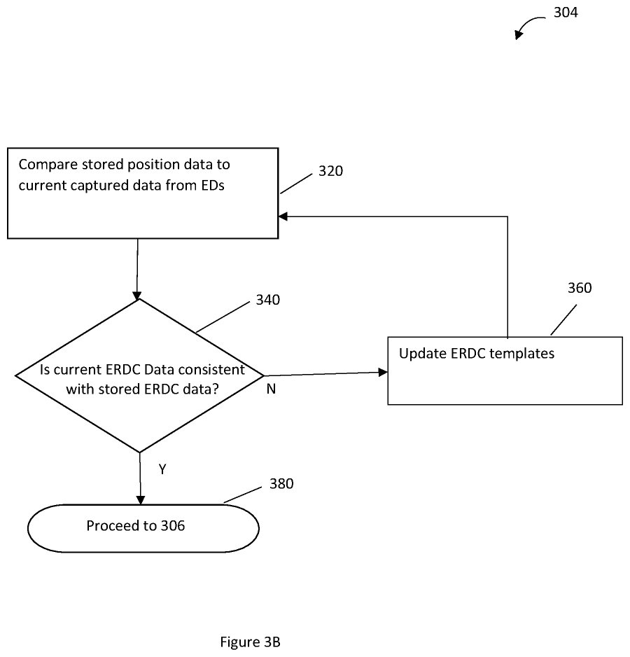

At 316, the one or more processors end process 300. For example, the one or more processors may determine that the tracking log has a sufficient amount of tracking data to properly calculate pathways to potential PSE destinations. Accordingly, the one or more processors may end the process. FIG. 4 illustrates a process 400 for identifying a recommended pathway through a PSE to a PSE destination in accordance with embodiments herein. While the operations of FIG. 4 are illustrated as a common continuous flow, it is recognized that anyone or more of the different subsections may be implemented alone or in different combinations. For example, one or more of the different types of templates may be collected alone or in combination with one or more of the other types of templates.

At 402, one or more processors obtain an indication of a PSE destination. For example, the indication of a PSE destination may be entered by an individual into an ED, such as when the individual desires to walk to the individual's next meeting. Optionally, the indication may be automatically generated by the ED, based on a calendar invite stored in the calendar application on the ED. The calendar invite may provide location, date, and time information for a meeting. Optionally, the indication may be automatically generated by the ED, based on a prior or real time invitation received through text, email or other application, prior history (e.g., weekly meetings) and the like. The ED may allow the PSE navigation system to access the aforementioned applications, using the schedule/meeting information discovered in the ED within meeting invites, texts, emails, and the like to create an indication of a PSE destination for each event.

For example, in FIG. 5B, ED 550 may enter into a PSE. Being unfamiliar with the PSE, one or more direct requests may be entered into an app for a route to a PSE destination, such as Conference room 515. The request becomes the indication of the PSE destination. Alternatively, the ED may automatically generate the request for a PSE destination upon the user's entrance within the PSE boundary. The request may be based on a scheduled meeting invite from a calendar application, text, email, or some other indication of an upcoming meeting. The date, time, and location information may be obtained from the applications on the ED and provide the one or more processors with relevant schedule information required to establish an indication of a PSE destination. For example, the ED may have a meeting scheduled for today at 10 am in conference room 515. Upon entering the PSE, the ED may receive on its display, a message allowing the ED to opt-in to the PSE navigation system. Upon consent, the navigation connects to relevant applications, such as the calendar, on the ED that indicate upcoming meetings within the PSE. The one or more processors of the PSE navigation system then obtain an indication of a PSE destination. The PSE destination indication may be directions to navigate to conference 515 by 10 am for a meeting.

At 404, the one or more processors obtain a current location for an ED. For example, an ED may be located within the PSE via GPS data, ERDC data, dead reckoning data, and/or WiFi node data. The GPS data may locate the ED in terms of longitude and latitude coordinates within the PSE. The ERDC data may locate the ED based on a comparison of pictures, video, and/or audio captured along prior pathways and the pictures, video, and/or audio captured by the current ED in its current location. ERDC data such as views and sounds of particular doors opening and closing or lights in a hallway may be used to determine that the ED is located by an exit door near the end of the hallway. Dead reckoning data may be used to locate an ED based on the previously known location of the ED the speed and direction of the ED movement may provide a current location for the ED. WiFi node data may provide a current location for an ED by using triangularization to locate the ED based on WiFi signal strength.

At 406, the one or more processors obtain one or more prior pathways through a PSE followed by a collection of EDs over time in connection with the EDs navigating through the PSE. Optionally, obtaining prior pathways may also include accessing the memory that stores the prior pathways that are built by tracking position data for the collection of EDs over time while the EDs navigate through the PSE in addition to identifying potential PSE destinations within the PSE and analyzing position data to identify the prior pathways through the PSE to corresponding ones of the potential PSE destinations. Optionally, the position data may be recorded in a tracking log that includes a starting location, a destination, route information, and potential PSE destinations. For example, the prior pathways may be obtained from a database or other memory, where the prior pathways have been previously calculated by one or more EDs, a remote server and the like. The various pathways taken by the one or more EDs are collected by the one or more processors in a tracking log that may store starting locations, destinations, routes, and potential PSE destinations. The prior pathways are compiled over a time period determined by the one or more processors.

In FIG. 5B, for example, pathways 561a-d and 571a-d are prior pathways tracked from users with EDs 560 and 571. The users may have been tracked along these routes for one or more days, weeks, or years. Optionally, the one or more processors may continuously compile the prior pathways or may cease obtaining pathways after a period of time or after a certain number of pathways has been collected by the one or more processors. For example, the one or more processors may be configured to cease obtaining pathways after every combination of pathways and PSE destinations has been tracked hundreds of times from multiple EDs. As in FIG. 2, the routes of the EDs may be recorded in tracking log 127. The tracking log 127 may be accessed by the one or more processors to obtain prior pathways within a PSE. The tracking log may track starting locations, destinations, routes, and PSE destinations of previously tracked EDs.

At 408, the one or more processors analyze the prior pathways to a PSE destination. The one or more processors determine that the various prior pathways are valid routes to a PSE destination. For example, the one or more processors may compare multiple pathways to a PSE destination to determine which route is shortest, quickest, r which route may be best for multiple PSE destinations, or based on other criteria.

For example, in FIG. 5B, the prior pathways 571a-b may be analyzed and compared with prior pathway 561b for an ED with a meeting in conference room 515. Prior pathway 561b may be analyzed to be quicker, but pathways 571a-b may be better for an ED user needing to make copies of handouts for the upcoming meeting in conference room 515. For example, the current ED may contain a text or email regarding a need for providing copies of handouts for the upcoming meeting. A text to an associate may state, “Hi Paul. I will not be able to visit prior to the meeting re: project 2 today at 10 am in conference room 515, because I need to make 10 copies of my handouts to distribute to the attendees.” The text, email, or the handout documents themselves may contain date, time, subject, and/or location information that is identified by the one or more processors of the PSE navigation system. The one or more processors may use the information during the analysis process to provide a useful pathway for the ED.

Optionally, the prior pathways may be calculated in real time by the one or more processors. For example, the pathways may be calculated utilizing the data from an ED as it moves throughout the PSE. Rather than utilize stored data, the processor may calculate the prior pathway immediately using the data from the ED. In operation, the ED's location based on information from a calendar invite, text, and the like may be calculated in real time based on the current information that the processor has regarding the ED's current location and destination.

At 410, the one or more processors save one or more prior pathways to a PSE destination. The prior pathways may be saved in a local server. Optionally the prior pathways may be saved in a remote server. For example, in FIG. 5B, the prior pathways 561b and 571c may be saved by the one or more processor as prior pathways to conference room 515.

At 412, the one or more processors determine a recommended pathway through the PSE to a PSE destination based on the one or more prior pathways. For example, the one or more processors may have prior pathways based on a route taken by several EDs. A recommended pathway may be determined by the one or more processors based on calculating the pathways to a PSE destination from the collection of prior pathways taken from previous EDs. Parameters, such as the time to travel the pathway may be a consideration for a recommended pathway. Optionally, the user may want a recommendation based on other factors, such as a pathway with a restroom along the way, a pathway with a coffee machine, or a pathway that goes by an associate's office. Optionally, the recommended pathway may be calculated using the current location of an ED, the PSE destination, and the ERDC data defining the one or more pathways.

For example, as illustrated in FIG. 5B, the one or more processors determine a recommended pathway through the PSE to a PSE destination responsive to ED 550 making a request for directions to the PSE destination. The recommended pathway responsive to ED 550 proceeding to the conference room 515 may be pathway 551 (solid arrows) for a user entering the doors near the stairwell. However, if ED 550 proceeds to other PSE destinations, such as the kitchen area 520, the one or more processors may determine other recommended pathways, such as 551f (dotted arrows) to the conference room 515 based on prior pathways and ERDC data associated with ER 550.

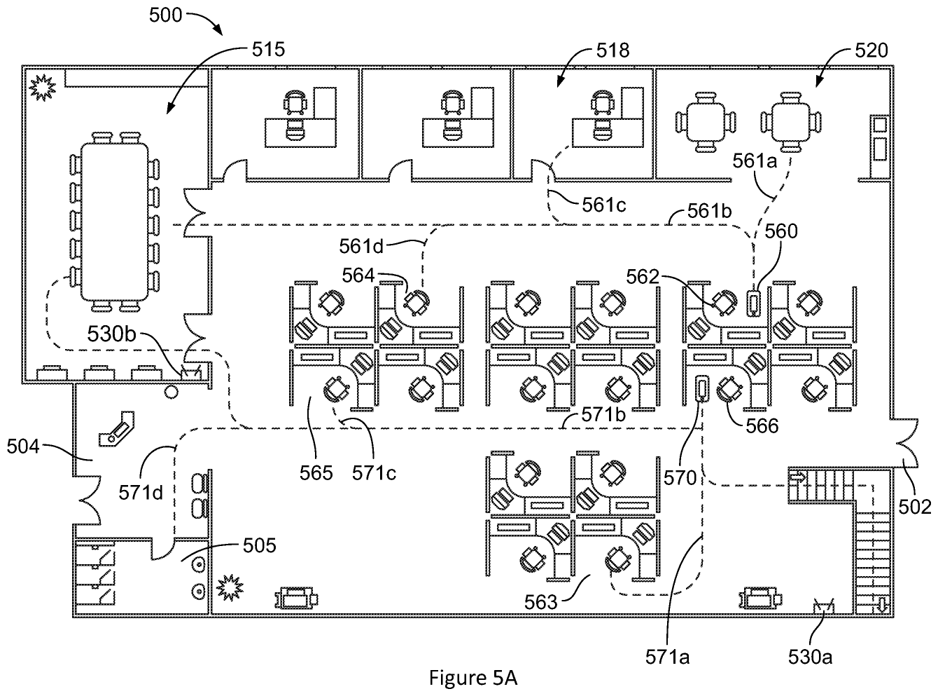

As another example, as illustrated in FIG. 6, the one or more processors may determine a recommended pathway independent of geographic mapping data. The one or processors may determine a recommended pathway to a PSE destination based on a collection of prior pathways such as 611, 621, 631, and 641 of tracked EDs 610, 620, 630, and 640, respectively. Mapping data such as floor plans, room numbers, and the like may not be available. However, recommended pathways to PSE destinations may still be determined based on a location of a current ED tracked by GPS, dead reckoning, and/or WiFi nodes 635a and 635b. The one or more processors may determine the recommended pathway based on a calculation of the current ED location, the PSE destination, and the stored prior pathways.

At 414, the one or more processors present the recommended pathway. The recommended pathway may be presented in an audio, video, and/or tactile manner. For example, the recommended pathway may be presented as audio, visual, and/or tactile information. An audio-based recommended pathway to a PSE destination may be presented as turn-by-turn directions within the PSE, such as “turn left at the next corner and your meeting room is on the first room on the right.” A visual-based recommended pathway may be presented as arrows on a display providing directions as illustrated in FIG. 7, the arrows indicating where to proceed and turn as required. Optionally, the recommended pathway may be presented by displaying the recommended pathway on a display of an augmented reality (AR) device. A tactile-based recommended pathway to a PSE destination may be presented as a vibration of the ED indicating the need to proceed or turn. The tactile-based presentation may be in tandem with the audio and/or visual presentation of the recommended pathway.

For example, in FIG. 5B, pathway 551 (solid arrows) may represent the recommended pathway for ED 550. The pathway may be to the PSE destination chosen by the user upon entering the PSE. The user of the ED in FIG. 7 would be presented an arrow in the display of the user's cellphone indicating the recommended pathway. The user of the ED in FIG. 9 would be presented an arrow in the display of the user's AR goggles indicating the recommended pathway.

Optionally, the user of the ED may desire a pathway that provides other desired stops along the recommended pathway, such as the kitchen area 520, the restroom 505, and the like. The one or more processors provide the PSE pathway with the criteria selected by the ED user. For example, in FIG. 5, the user having ED 550 may decide to stop at restroom 505, taking prior pathway 551c prior to arriving at the PSE destination 515, the conference room. Making a visit to an associate in cubicle 564 may result in ED 550 being presented pathway 551f, which leads to pathway 551h as a recommended pathway to the associate in cubicle 564.

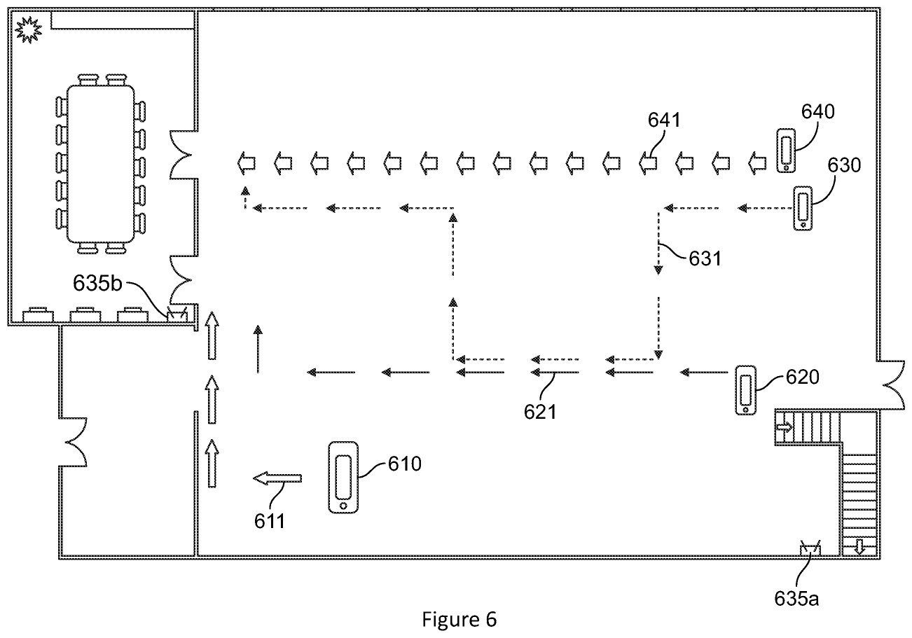

Optionally, the recommended pathway may be presented with multiple prior pathways, emphasizing the recommended pathway amongst the one or more prior pathways. As illustrated in FIG. 8, the recommended pathway to a PSE destination may be highlighted among the prior pathways in a display of an ED. The prior pathways may be illustrated in various sizes, colors, or shapes to differentiate the recommended pathway.

At 416, the one or more processors end the process 400. For example, the one or more processors may determine that the ED arrived at the requested PSE destination. The process may now end until another indication for another PSE destination request is received by the one or more processors from the same ED or another ED.

FIG. 5A illustrates a bird's eye view of a PSE environment 500. In an embodiment, ED 560 may proceed from cubicle 562 to the kitchen area 520 for coffee along pathway 561a. ED 560 may be tracked via one or more of GPS, dead reckoning, or WiFi nodes 530a and 530b. ED 560 may also proceed to a colleague in office 518 along pathway 561c. After leaving the colleague's office 518, ED 560 may proceed to another colleague in cubicle 564 along pathway 561c. The user may then walk from cubicle 564 to the conference room 515 along pathway 561b. The pathway data is collected and stored by one or more processors. The pathway data becomes part of a collection of prior pathways and is used to recommend pathways to a user seeking a PSE destination within a PSE.

Also illustrated in FIG. 5A, ED 570 may leave cubicle 566 and proceed to cubicle 563 along pathway 571a. ED 570 may proceed down the hall along pathway 571b to cubicle 565 along pathway 571c. ED 570 may decide to proceed to the conference room 515 by continuing along pathway 571b. Also, ED 570 may also proceed to the restroom 505 along pathway 571d. The pathway data is collected and stored by one or more processors. The pathway data becomes part of a collection of prior pathways and is used to recommend pathways to a user seeking a PSE destination within a PSE.

FIG. 5B illustrates a bird's eye view of a PSE environment 500. In an embodiment, ED 550 may enter through PSE back doors 502 and be presented a notification to download an app that provides recommendations to the PSE destinations needed by the user. After opting in, ED 550 may proceed to make requests for available PSE destinations. Directions to the PSE destinations may be determined by calculations made from the prior pathways taken by other users with EDs, such users 560 and 570. The EDs may have been tracked via GPS, dead reckoning, and/or WiFi node-2 530a and node-1 530b. The recommended pathway 551 (solid arrows) for the fastest route to conference room 515 is presented to ED 550. Pathways 551a-h (dotted arrows) may represent routes to PSE destinations that are the most frequently traveled in the PSE. These pathways present ways to navigate to potential PSE destinations for ED 550. For example, ED 550 may go the kitchen area 520 for coffee. A request made by ED 550 provides the fastest pathway 551d to the kitchen area 520. ED 550 may then proceed to an associate's cubicle 562 to discuss agenda items prior to the meeting in the conference room 515. Pathways 551f and 551e may be the pathway presented to ED 550. After the meeting, ED 550 may proceed downstairs along pathway 551a to a snack machine (not shown). Pathways used by ED 550 in the PSE are collected and stored by one or more processors as prior pathways for future PSE destination requests.

FIG. 6 illustrates a bird's eye view of a PSE environment. In an embodiment, the PSE environment contains multiple EDs tracked by one or more processors. This illustration represents the pathways traveled by the multiple EDs. No mapping of offices or other floor plan items are utilized by the one or more processors in this embodiment. The one or processors track the pathways traveled by the EDs and store the data as prior pathways. The tracking of the EDs may still be provided by GPS, dead reckoning, and/or WiFi nodes. The pathway 641 is tracked by the one or more processors from the movement of ED 640. WiFi node-1 635b and node-2 635a track the pathways taken by ED 640 within the PSE. The pathway 641, after being obtained, stored and analyzed, becomes a prior pathway. Pathways 611, 621, and 631 are similarly tracked and also become prior pathways. The prior pathways are used to calculate potential PSE destinations and provide a PSE destination when requested by an ED.

FIG. 7 illustrates an embodiment where ED 700 is presented a view of the hallway in the PSE. The user is presented a recommended pathway after making a PSE destination request. The recommended pathway 705 is shown in the embodiment as AR arrows on the user's ED screen 710. The PSE destination is shown as a room 715 on the left side of the screen 710. Optionally, the directions to the user may be audio instructions, or a combination of audio and visual instructions. Upon following the instructions given by the one or more processors, ED 700 will arrive at the PSE destination 715 via the fastest way or via some other desired parameter entered by the user.

FIG. 8 illustrates the other prior pathways that proceed to the same PSE destination 815 as the recommended pathway 805. The one or more processors gather the prior pathways 820-860, store the pathways 820-860, and calculate the best pathway 860 after a PSE request is made. ED 800 is presented the recommended pathway 805 on the screen 810 of ED 800. The recommended pathway 805 is shown in the embodiment as AR arrows on the user's ED screen 810. The PSE destination is shown as a room 815 on the left side of the screen 810.

FIG. 9 illustrates an embodiment in which AR goggles 900 views a recommended pathway to a PSE destination. The AR goggles 900 may be non-limiting examples such as Google glass, the Epson Moverio, and the Toshiba dynaEdge AR100 Viewer. The one or more processors may present the recommended pathway 905 to the PSE destination 915 as AR arrows displayed in one or more lenses 910 of the AR goggles 900. The user may determine which lenses 910 provide the AR information. Optionally, the recommended pathway 905 may be presented via audio instructions or in a combination of the visual and audio instructions. As noted in previous embodiments, the one or more processors calculate the PSE destination 915 based on prior pathways.

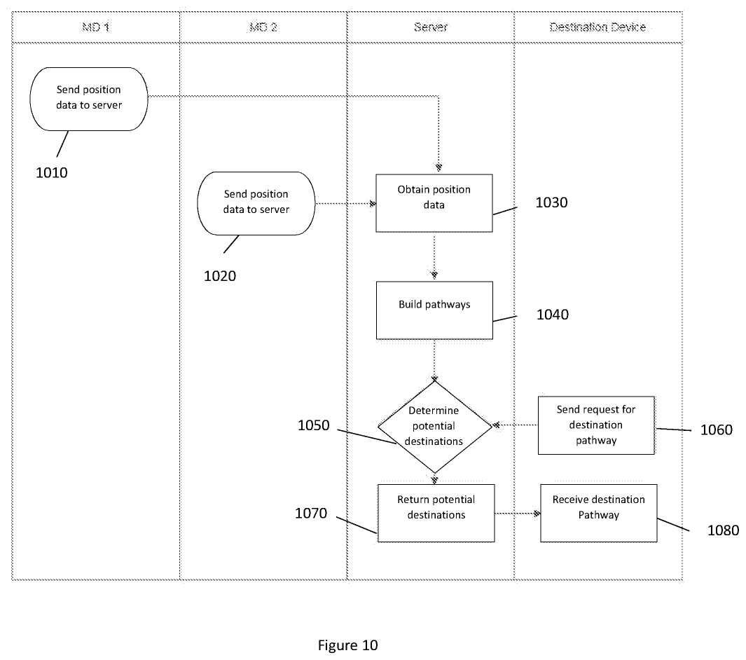

FIG. 10 illustrates communications between devices in association with providing a recommended PSE destination. At 1010 the tracked ED sends position data to the one or more processors. The ED position data may be tracked via GPS, dead reckoning, and/or WiFi nodes. The various pathways taken by this ED are gathered and stored as prior pathways. The ED also provides ERDC data to the one or more processors. The data may be images, videos, or sounds associated with the various locations within the PSE. For example, as illustrated in FIG. 5, ED 560 may proceed along pathway 561b to conference room 515. ED 560 may travel the pathway every day for a period of days, months, and years. Each route is gathered and stored. At 1020 another tracked ED sends position data to the one or more processors. The ED position data may be tracked via GPS, dead reckoning, and/or WiFi nodes. The various pathways taken by this ED are gathered and stored. The ED also provides ERDC data to the one or more processors. The data may be images, videos, or sounds associated with the various locations within the PSE. For example, as illustrated in FIG. 5, ED 570 may proceed along pathway 571b to conference room 515. ED 570 may travel the pathway every day for a period of days, months, and years. Each route is gathered and stored. The data is obtained at 1030. After analysis by the one or more processors, each of the routes may be used to build pathways. Each of the routes may become prior pathways in a collection of pathways stored by the one or more processors for use as a way to provide navigation to a PSE destination at 1040. At 1050 the server uses the data from the collection of pathways along with the request from an ED for a PSE destination 1060 to determine potential PSE destinations. After calculating potential destinations, the one or more processors return potential destinations at 1070. Potential PSE destinations may be a conference room, an office, the kitchen area, and the like, that are along a prior pathway. Finally, at 1080 the user receives the recommended pathway to the requested PSE destination. The recommended pathway to a PSE destination may be displayed as a pathway with arrows on an ED display as shown in FIG. 7. Additionally, or alternatively the recommended pathway may be displayed on one or more lenses of a pair of AR goggles as illustrated in FIG. 9.

### Closing Statements

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the Figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. A method, comprising:
obtaining one or more prior pathways through a physical structure environment (PSE) followed by a collection of electronic devices (EDs) over time in connection with the EDs navigating through the PSE;
determining a recommended pathway through the PSE to a PSE destination based on the one or more prior pathways followed by the collection of EDs; and
presenting the recommended pathway.

2. The method of claim 1, wherein the recommended pathway is determined independent of any geographic mapping data associated with the PSE.

3. The method of claim 1, wherein the presenting comprises presenting the recommended pathway as one or more of audio, visual and tactile information.

4. The method of claim 3, further comprising presenting the recommended pathway by displaying the recommended pathway on a display of an augmented reality (AR) device.

5. The method of claim 1, wherein the presenting further comprises presenting multiple of the one or more prior pathways and emphasizing the recommended pathway amongst the one or more prior pathways.

6. The method of claim 1, wherein the one or more pathways are defined based on environmental related device captured (ERDC) data.

7. The method of claim 6, wherein the obtaining includes accessing memory storing the one or more prior pathways that are built by:
tracking position data for the collection of EDs over time while the EDs navigate through the PSE;
identifying potential PSE destinations within the PSE; and
analyzing the position data to identify the one or more prior pathways through the PSE to corresponding ones of the potential PSE destinations, wherein the one or more prior pathways to the PSE destinations are updated based on the ERDC data.

8. The method of claim 7, wherein the position data is recorded in a tracking log and includes a starting location, a destination, route information, tracking data, and potential PSE destinations.

9. The method of claim 7, wherein the recommended pathway is calculated using a current location of an ED of the collection of EDs, the PSE destination, and the ERDC data defining the one or more pathways.

10. A system, comprising:
a user interface;
a processor;
a memory storing program instructions accessible by the processor, wherein, responsive to execution of the program instructions, the processor to perform the following:
obtain one or more prior pathways through a physical structure environment (PSE) followed by a collection of electronic devices (EDs) over time in connection with the EDs navigating through the PSE;
determine a recommended pathway through the PSE to a PSE destination based on the one or more prior pathways followed by the collection of EDs; and
present the recommended pathway.

11. The system of claim 10, wherein, responsive to execution of the program instructions, the processor determines the recommended pathway independent of any geographic mapping data associated with the PSE.

12. The system of claim 10, wherein, responsive to execution of the program instructions, the processor presents the recommended pathway as one or more of audio, visual and tactile information.

13. The system of claim 10, wherein, responsive to execution of the program instructions, the processor presents the recommended pathway by displaying the recommended pathway on a display of an augmented reality (AR) device.

14. The system of claim 10, wherein, responsive to execution of the program instructions, the processor presents multiple of the one or more prior pathways and emphasizes the recommended pathway amongst one or more prior pathways.

15. The system of claim 10, wherein, responsive to execution of the program instructions, the processor accesses memory to obtain the one or more prior pathways, wherein the processor tracks position data for the collection of EDs over time while the EDs navigate through the PSE, identifies potential PSE destinations within the PSE, and analyzes the position data to identify the one or more prior pathways through the PSE to corresponding ones of the potential PSE destinations to build the one or more prior pathways.

16. The system of claim 10, wherein, responsive to execution of the program instructions, the processor accesses memory to record position data in a tracking log, the tracking log including a starting location, a destination, route information, and potential PSE destinations.

17. The system of claim 10, wherein, responsive to execution of the program instructions, the processor accesses memory to calculate the recommended pathway using a current location of an ED of the collection of EDs, the PSE destination, and environmental related device captured (ERDC) data defining the one or more pathways.

18. A computer program product comprising a non-signal computer readable storage medium comprising computer executable code to perform:
obtaining one or more prior pathways through a physical structure environment (PSE) followed by a collection of electronic devices (EDs) over time in connection with the EDs navigating through the PSE;
determining a recommended pathway through the PSE to a PSE destination based on the one or more prior pathways followed by the collection of EDs; and
presenting the recommended pathway.

19. The computer program product of claim 18, further comprising presenting the recommended pathway by displaying the recommended pathway on a display of an augmented reality (AR) device.

20. The computer program product of claim 18, wherein the presenting further comprises presenting multiple of the one or more prior pathways and emphasizing the recommended pathway amongst one or more prior pathways.
